(19) United States
(12) Patent Application Publication
(10) Pub. No.: US 2016/0123331 A1
(43) Pub. Date: May 5, 2016

(54) Solar and wind powered blower utilizing a flywheel and turbine

(71) Applicant: Martin Eugene Nix, Seattle, WA (US)

(72) Inventor: Martin Eugene Nix, Seattle, WA (US)

(21) Appl. No.: 14/121,897

(22) Filed: Oct. 31, 2014

(51) Int. Cl. F04D 25/02; F04D 25/04; F01D 15/08; F04D 25/16; F04D 29/42; F03D 9/00; F04D 17/08; F04D 25/06

(52) U.S. Cl. CPC F04D 25/024; F04D 17/08; F04D 25/045; F04D 25/06; F04D 25/16; F04D 29/4206; F03D 9/001; F01D 15/08; F05D 2220/70; F05D 2260/43

(57) ABSTRACT

Developed is a blower to make compressed and high velocity air, using a solar powered electric blower, a wind powered blower, or a wind shroud. The compressed and high velocity air drives a turbine attached to a flywheel, thus overcoming the variability of wind and solar energy. Check valves are utilized. Thus providing compressed and high velocity air 24 hours a day, 7 days a week, year round. (68 words)

### FIELD OF INVENTION

Developed is a blower powered by a photovoltaic cell, a wind turbine or a wind shroud, to drive a flywheel and turbine assembly.

### PRIOR ART

Nix (U.S. Pat. No. 5,488,801, issued Feb. 6, 1996) illustrates the use of a photovoltaic cell to drive a electric fan for cooling air to a greenhouse.

Nix (U.S. patent application Ser. No. 11/634,312, Filing date Dec. 5, 2006. Projected publication date Jun. 5, 2008) illustrates the use of flywheels for blowing compressed and high velocity air. FIG. 15 illustrates a electric motor driving a flywheel and a centrifuge blower. Paragraphs [0216] and [0196] describe the blower's operation.

Nix (U.S. Pat. No. 8,776,785, issued Jul. 15, 2014) illustrates the utilization of a blower to move air through embedded pipes, heating the air via solar energy in a thermal mass.

Nix (U.S. patent application Ser. No. 13/986,595, Filing date May 16, 2013. Projected publication date Nov. 20, 2014) illustrates the use of a solar smelter to preheat hot air to a turbine inside a wind chimney, thus powering rotating machinery.

Solar photovoltaic cells can provide electrical power to a electric blower. A wind turbine can provide electrical power to a electric blower or drive a blower via mechanical or hydraulic force. Wind shroud technology is an ancient technology, utilized today for cooling of buildings. Wind shrouds capture the wind, and blow the air downwards via a chimney. Flywheels and turbines are known technology. Check valves are a known technology. The above prior art illustrate the invented device is feasible.

### SUMMARY OF INVENTION

Wind and solar energy tend to be variable during the day. Often solar energy is very available in the summer, when wind energy is not as available. However, wind energy tends to be very available in the winter, when solar energy is not available. By adding a flywheel and turbine assembly, the kinetic energy from solar and wind energy can be stored. Thus, stabilizing the compressed and high velocity air from a blower. Check valves can be added to assure that the compressed and high velocity air blows in the proper direction.

Developed is a first blower that is electrically powered, from the electricity generated by a photovoltaic cell. The first blower blows compressed and high velocity air at a turbine, which is attached to a rotating flywheel. Check valves direct the compressed and high velocity air in the proper direction, preventing black flow. The flywheel and turbine assembly stores the solar energy in the form of kinetic energy, thus providing compressed and high velocity air when solar energy is not available.

Developed is a second blower that is wind powered, from a wind turbine. The second blower can be powered by electricity, or directly via mechanical energy, or from hydraulic pressure. The second blower blows compressed and high velocity air at a turbine, which is attached to a rotating flywheel. Check valves direct the compressed and high velocity air in the proper direction, preventing black flow. The flywheel and turbine assembly stores the solar energy in the form of kinetic energy, thus providing compressed and high velocity air when wind energy is not available.

Developed is a third blower that is wind powered, from a wind shroud. The third blower directs compressed and high velocity air from wind downwards a chimney. The third blower blows compressed and high velocity air at a turbine, which is attached to a rotating flywheel. Check valves direct the compressed and high velocity air in the proper direction, preventing black flow. The flywheel and turbine assembly stores the solar energy in the form of kinetic energy, thus providing compressed and high velocity air when wind energy is not available.

A casing surrounds the flywheel and turbine assembly, so as to entrap compressed and high velocity air. A plurality of the first blower, the second blower, and the third blower may be combined so as to provide compressed and high velocity air 24 hours a day, 7 days a week, year round. Compressed and high velocity air may be blown into a solar collector, to make hot air, for example.

### DESCRIPTION OF FIGURES

FIG. 1 illustrates an overhead view of the invented device. Shown is a turbine and flywheel assembly inside a casing. There is one inlet for compressed and high velocity air, a outlet for compressed and high velocity air, a vacuum lock for high velocity air, and a check valve.

FIG. 2 illustrates a cross sectional view of the invented device. Shown is a turbine and flywheel assembly inside a casing.

FIG. 3 Illustrates the utilization of a photovoltaic cell to power a first blower that is electrically powered. The first blower manufactures compressed and high velocity air for a flywheel and turbine assembly inside a casing.

FIG. 4 Illustrates the utilization of a wind turbine to power a second blower that can be electrically driven, but can be hydraulically or mechanically driven or other suitable means. The second blower manufacturers compressed and high velocity air for a flywheel and turbine assembly inside a casing.

FIG. 5A illustrates the utilization of a wind shroud to blow air down the wind shroud. Shown is a frontal view of the wind shroud. FIG. 5B shows a cross sectional side view of a wind shroud. This third blower manufacturers compressed and high velocity air for a flywheel and turbine assembly inside a casing.

FIG. 6 illustrates a plurality of the first blower, the second blower and the third blower. By combining, it helps to reduce the variability of wind and solar energy. Thus providing compressed and high velocity air, 24 hours a day, 7 days a week, year round.

FIG. 7 illustrates a typical utilization of compressed and high velocity air from the invented device. Shown is a typical flat plate solar collector, heating the compressed and high velocity air for a converted natural gas hot water tank, thus making water hot.

FIG. 8 illustrates the utilization of a solar smelter to heat compressed and high velocity air from the invented device for a turbine embedded inside a wind chimney. The turbine thus drives rotating machinery, such as a generator, water pump, air compressor, or another flywheel.

### DETAILED DESCRIPTION

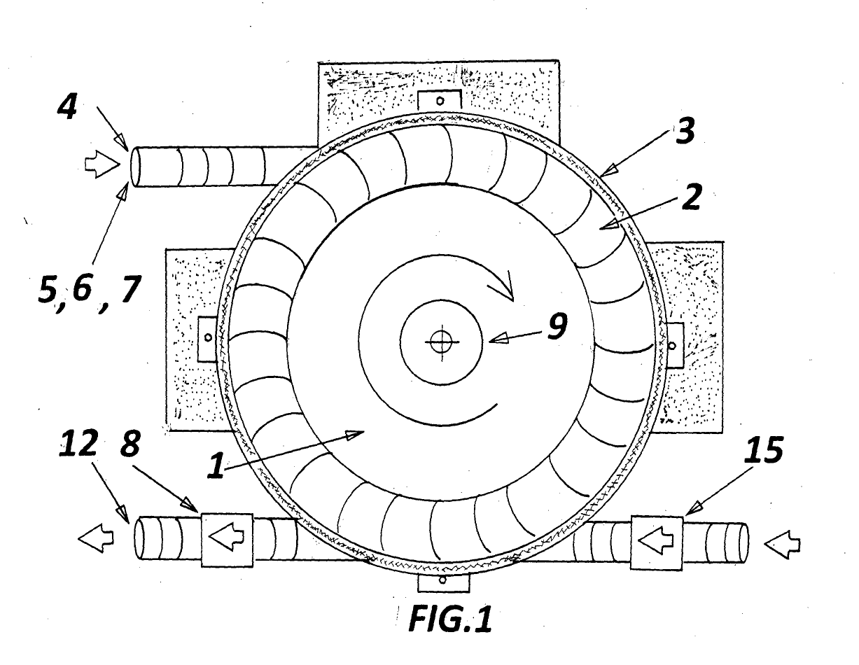

FIG. 1 illustrates an overhead view of the invented device. Shown is a flywheel (1) and turbine (2) assembly, surrounded by a casing (3). Shown is an air inlet (4) for compressed and high velocity air from a first blower (5), a second blower (6), or a third blower (7). A check valve (8) on the air outlet (12) directs the flow of the compressed and high velocity air in the proper direction, and prevents black flow. Bearings (9) for the flywheel and turbine (1,2) assembly reduces friction, and can be metal ball bearings, or compressed air bearings, or magnetic bearings (9). A vacuum lock (15) allows ambient air to enter the casing (3) when the kinetic energy is withdrawn from the flywheel (1) and turbine (2) assembly.

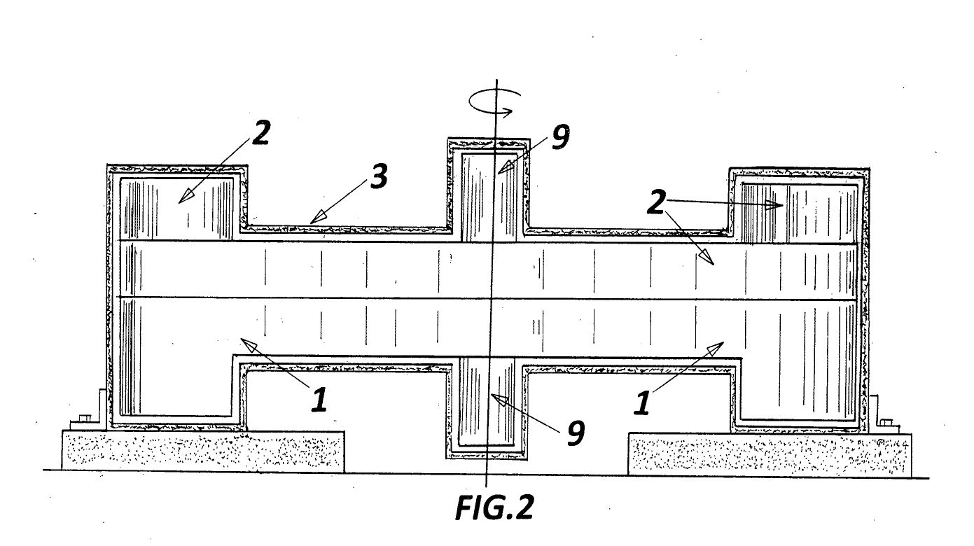

FIG. 2 illustrates a cross sectional view of the invented device. Shown is a flywheel (1) and turbine (2) assembly, inside a casing (3). Bearings (9) for the flywheel (1) and turbine (2) assembly can be metal ball bearings, or compressed air bearings, or magnetic bearings .

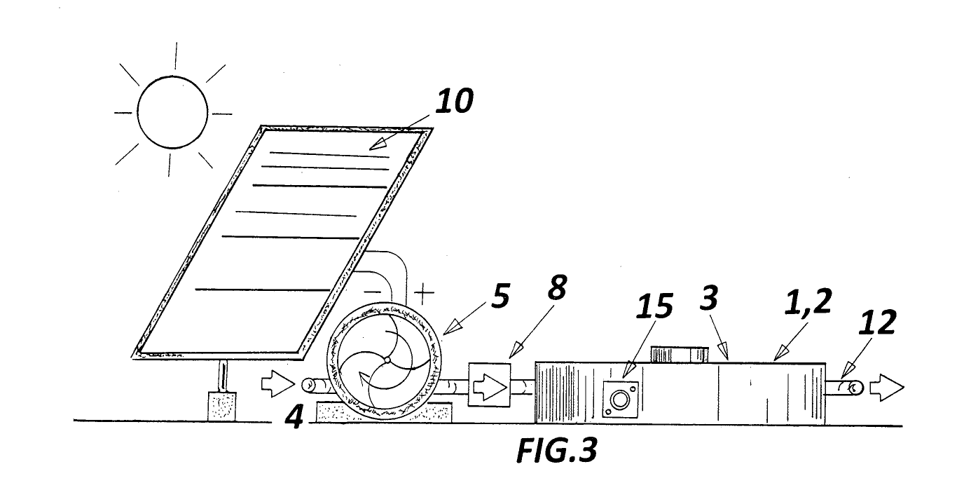

FIG. 3 illustrates a first blower (5) that is powered by a photovoltaic cell (10) via a electric motor (5). Shown is a air inlet (4) that directs compressed and high velocity air to a flywheel and turbine (1,2) assembly, thus storing the solar energy in the form of kinetic energy. Kinetic energy during none solar periods provides compressed and high velocity air to the air outlet (12). A check valve (8) can be added so as to direct the proper flow of the compressed and high velocity air. A casing (3) surrounds the flywheel and turbine (1,2) assembly. A vacuum lock (15) allows ambient air to enter the casing (3) when kinetic energy is withdrawn from the flywheel and turbine (1,2) assembly.

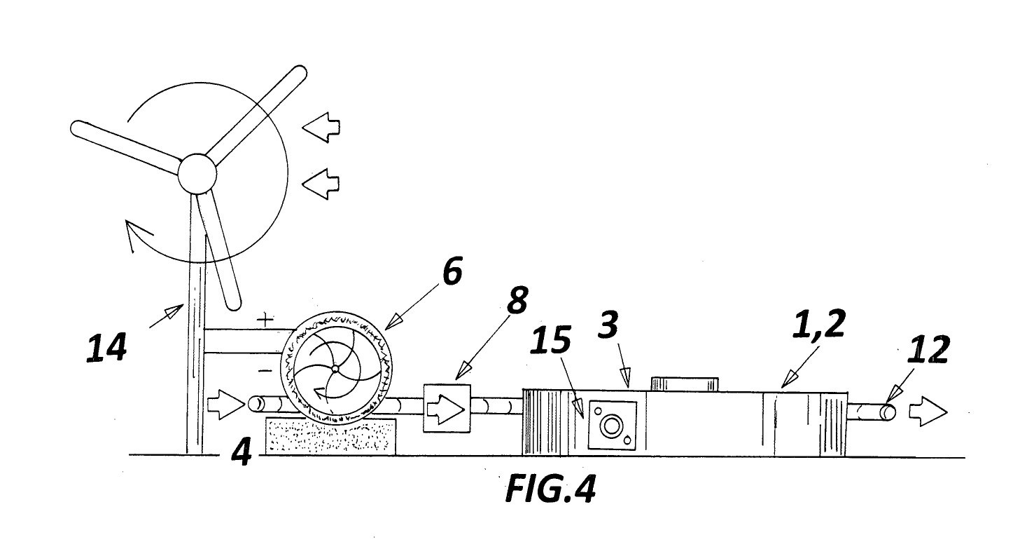

FIG. 4 illustrates a second blower (6) that is powered by a wind turbine (14). Compressed and high velocity is created by a second blower (6) that can be electrically driven, or via a mechanical or a hydraulic drive. Shown is a electrically driven second blower (6) with a electric motor (6), but can be mechanical, hydraulic or other suitable means. Shown is a air inlet (4) that directs compressed and high velocity air to a flywheel and turbine (1,2) assembly, thus storing the wind energy in the form of kinetic energy. Kinetic energy during none solar periods provides compressed and high velocity air to the air outlet (12). A check valve (8) can be added so as to direct the proper flow of the compressed and high velocity air. A casing (3) surrounds the flywheel and turbine (1,2) assembly. A vacuum lock (15) allows ambient air to enter the casing (3) when kinetic energy is withdrawn from the flywheel and turbine (1,2) assembly.

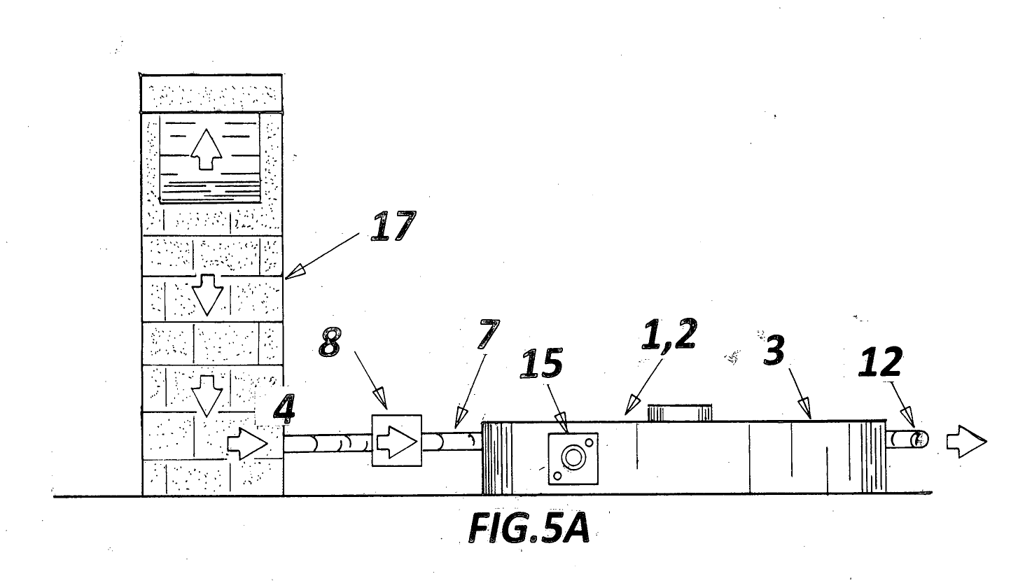

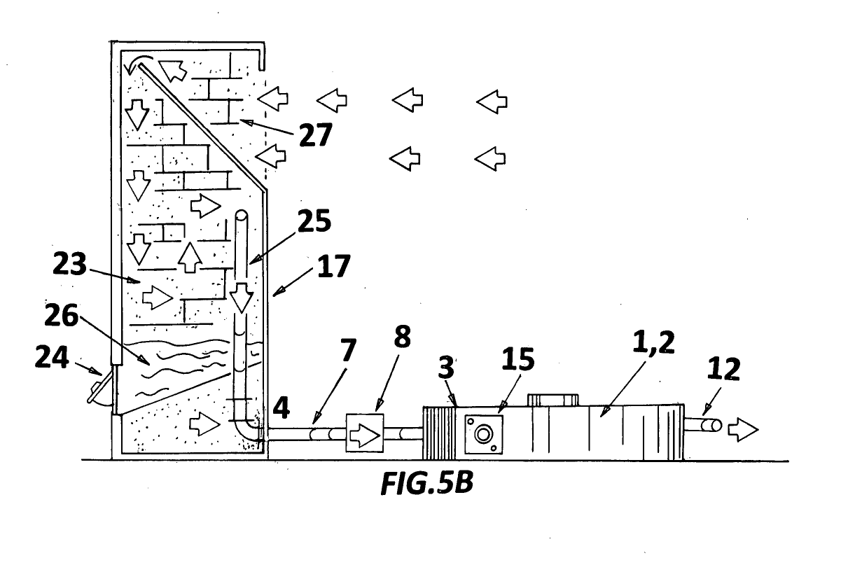

FIG. 5A illustrates a third blower (7) powered by a wind shroud (17). This is known ancient technology, where compressed and high velocity air from wind is blown down a wind shroud (17). Shown is a air inlet (4) that directs compressed and high velocity air to a flywheel and turbine (1,2) assembly, thus storing the solar energy in the form of kinetic energy. Kinetic energy during none wind periods provides compressed and high velocity air to the air outlet (12). A check valve (8) can be added so as to direct the proper flow of the compressed and high velocity air. A casing (3) surrounds the heel and turbine (1,2) assembly. A vacuum lock (15) allows ambient air to enter the casing (3) when kinetic energy is withdrawn from the flywheel and turbine (1,2) assembly.

FIG. 5B illustrates a third blower (7) powered by a wind shroud (17). This is known ancient technology, where compressed and high velocity air from wind is blown down a wind shroud (17). Wind enters the wind shroud (17) at the head (27) and then is compressed into a large chamber (23). The large chamber, due to the slowing velocity of the wind, removes dust (26) from the atmosphere. The dust (26) is collected and then removed via a trap door (24). The compressed and high velocity air then enters a pipe (25), which goes to the third blower (7). Shown is a air inlet (4) that directs compressed and high velocity air to a flywheel and turbine (1,2) assembly, thus storing the solar energy in the form of kinetic energy. Kinetic energy during none wind periods provides compressed and high velocity air to the air outlet (12). A check valve (8) can be added so as to direct the proper flow of the compressed and high velocity air. A casing (3) surrounds the flywheel and turbine (1,2) assembly. A vacuum lock (15) that allows ambient air to enter the casing (3) when kinetic energy is withdrawn from the flywheel and turbine (1,2) assembly.

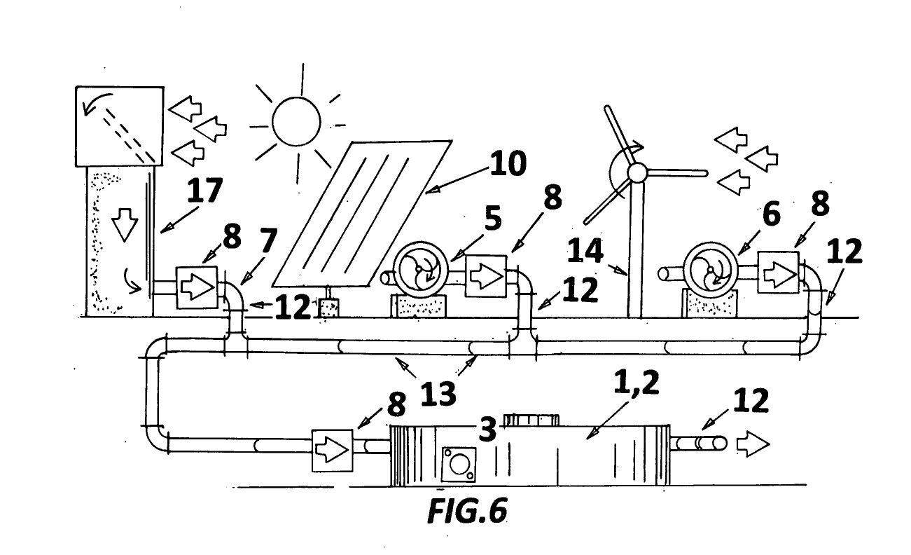

FIG. 6 illustrates a plurality of the first blower (5), the second blower (6), and the third blower (7). Shown is the flywheel and turbine assembly (1,2) and casing (3). Shown is the photovoltaic cell (10), the wind turbine (14), and the wind shroud (17). Check valves (8) direct the flow of the compressed and high velocity air from the air outlets (12) into a piping system (13). Check valves (8) may be located before or after the flywheel and turbine assembly (1,2), or as needed.

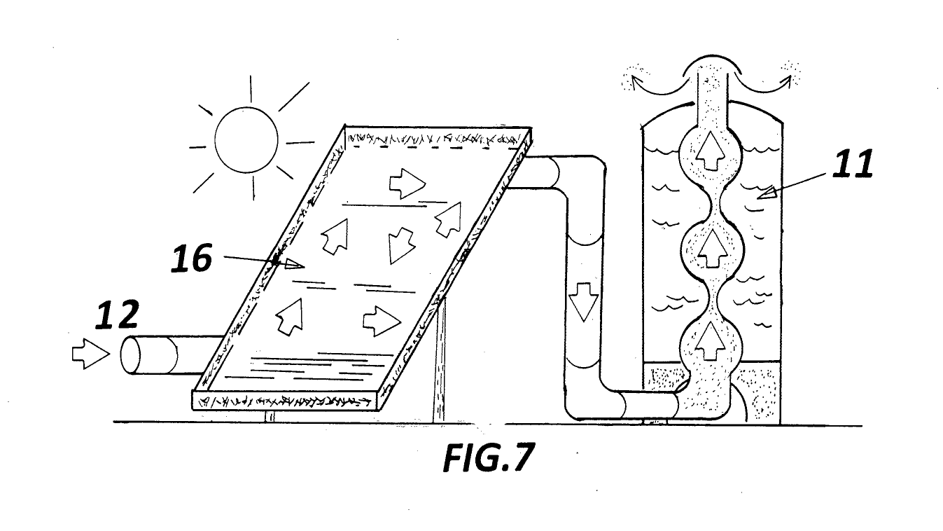

FIG. 7 illustrates a utilization of the compressed and high velocity air from the invented device. Shown is a typical solar flat plate collector (16) which heats the compressed and high velocity air. The heated compressed and high velocity air can be blown from the outlets (12), for example, to a converted natural gas hot water tank (11) to make hot water. But other applications abound, such as combustion air to a fossil fuel burner fireplace, hot air to a cooking stove, building exchange air, or space heat.

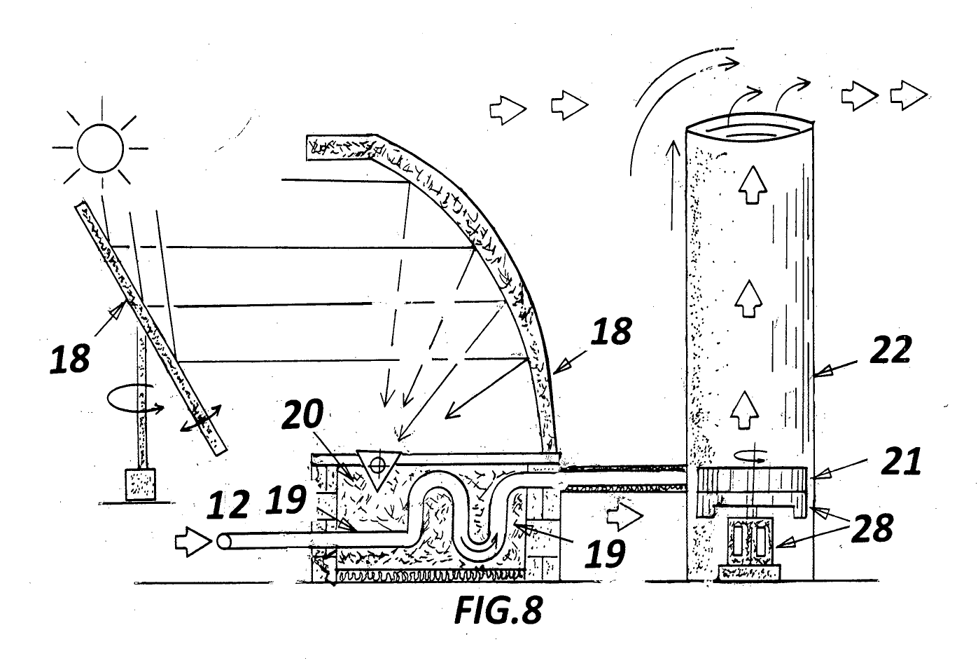

FIG. 8 illustrates another possible utilization of the compressed and high velocity air from outlets (12) of the invented device. Shown is a solar smelter (18) which heats compressed and high velocity air via pipes (19) embedded in a solar heated thermal mass (20). The heated compressed and high velocity air thus can be blown at a turbine (21) embedded inside a wind chimney (22), thus driving rotating machinery (28) which can be a generator, water pump, air compressor, or another flywheel.

The flow of compressed and high velocity air and also wind is shown by arrows.

1. A system for manufacturing compressed and high velocity air;
a first blower utilizing a photovoltaic cell to make electricity for a electric motor;
said first blower manufacturing said compressed and high velocity air into a casing via a air inlet;
a second blower utilizing a wind turbine;
said second blower manufacturing the compressed and high velocity air into said casing via said air inlet;
a third blower utilizing a wind shroud;
said wind shroud manufacturing the compressed and high velocity air into the casing via the air inlet;
the casing containing a turbine;
the casing containing a flywheel;
said turbine attached and adjacent to said flywheel about a common rotating axis;
the casing containing an air outlet;
the casing containing a check valve;
the casing containing a vacuum lock;
said system means to stabilize the variability of wind and solar energy and to stabilize compressed and high velocity air for utilization 24 hours a day, 7 days a week, year round.
